(19) United States
(12) Patent Application Publication
(10) Pub. No.: US 2020/0376812 A1
(43) Pub. Date: Dec. 3, 2020

(54) INTERLEAVED INSULATED FOIL SHEETS

(71) Applicant: PolySachi Polymers, Harlingen, TX (US)

(72) Inventors: Haresh Sachithanandan, Round Rock, TX (US); Velsamy Govindan, Hutto, TX (US); Pranab Sachithanandan, Round Rock, TX (US); Thillak Sachithanandan, Round Rock, TX (US)

(21) Appl. No.: 16/886,200

(22) Filed: May 28, 2020

Related U.S. Application Data
(60) Provisional application No. 62/855,488, filed on May 31, 2019.

(51) Int. Cl. B32B 15/20; B32B 15/14; B32B 7/12; B65H 45/30

(52) U.S. Cl. CPC B32B 15/20; B32B 15/14; B32B 2311/24; B65H 45/30; B32B 2307/304; B32B 7/12

(57) ABSTRACT

A plurality of interleaved insulated foil sheets including a plurality of insulated foil sheets, each including a foil layer, an adhesive layer disposed on the foil layer, and a paper layer disposed on the foil layer; wherein a first insulated foil sheet is folded to create a first crease dividing the first insulated sheet into a first upper leaf and a first lower leaf and a second insulated foil sheet is folded to create a second crease dividing the second insulated sheet into a second upper leaf and a second lower leaf; and wherein the first upper leaf of the first insulated foil sheet is disposed between the second upper leaf and the second lower leaf of the second insulated sheet and the second lower leaf of the second insulated foil sheet is disposed between the first upper leaf and the first lower leaf of the first insulated sheet.

### CROSS-REFERENCE TO RELATED APPLICATIONS

This application claims priority to U.S. Provisional Application Ser. No. 62/855,488, filed May 31, 2019, the entire contents of which are incorporated herein by reference.

### STATEMENT OF FEDERALLY FUNDED RESEARCH

Not applicable.

### TECHNICAL FIELD OF THE INVENTION

The present invention relates in general to the field of insulated foils sheets. In particular, the present invention relates to interleaving insulated foil sheets.

### BACKGROUND OF THE INVENTION

Insulated foil sheets are used in a variety of applications, including the wrapping of food in food vending businesses. It is convenient for such businesses to have insulated foil sheets packaged in interleaved lots so that pulling one sheet from the top of a lot deploys a portion of the next sheet, making it easier to grip and pull from the lot.

In the past, foil sheets including foil and paper held together by an adhesive have been difficult and expensive to interleave into lots because there tends to be an air gap between the aluminum/paper bilayer that does not exist in other interleaved materials, such as paper towels. This gap makes cutting the sheets much more difficult. In addition, the glue that holds the two layers together can be less effective in different interleaving orientations. Interleaved foil sheets that can be easily and cheaply interleaved are desirable.

### SUMMARY OF THE INVENTION

In some embodiments of the disclosure, a plurality of interleaved insulated foil sheets is disclosed as including a plurality of insulated foil sheets, each insulated foil sheet including a foil layer, an adhesive layer disposed on the foil layer, and a paper layer disposed on the foil layer; wherein a first insulated foil sheet of the plurality of insulated foil sheets is folded to create a first crease to divide the first insulated sheet into a first upper leaf and a first lower leaf and a second insulated foil sheet of the plurality of insulated foil sheets is folded to create a second crease to divide the second insulated sheet into a second upper leaf and a second lower leaf; and wherein the first upper leaf of the first insulated foil sheet is disposed between the second upper leaf and the second lower leaf of the second insulated sheet and the second lower leaf of the second insulated foil sheet is disposed between the first upper leaf and the first lower leaf of the first insulated sheet. In one aspect, the foil comprises aluminum. In another aspect, the adhesive comprises organic starch. In another aspect, the paper comprises craft paper. In another aspect, the first insulated foil sheet and the second insulated sheet are square or rectangular. In another aspect, the first crease is parallel to a first edge of the first insulated foil sheet and the second crease is parallel to a second edge of the second insulated foil sheet. In another aspect, the first insulated foil sheet or the second insulated foil sheet is folded such that the paper layer is inside the crease. In another aspect, the first insulated foil sheet or the second insulated foil sheet is folded such that the foil layer is inside the crease. In another aspect, the plurality of insulated foil sheets is packaged in a container. In another aspect, the container comprises an opening through which each interleaved insulated foil sheet of the plurality of insulated foil sheets is disposed to be extracted or deployed. In another aspect, adding one or more additional insulated foil sheets to the first or the second insulated foil sheets.

In some embodiments of the disclosure, a method of interleaving a plurality of insulated foil sheets is disclosed as including providing a first length of insulated foil and a second length of insulated foil, wherein the first length of insulated foil and the second length of insulated foil each comprise a foil layer, an adhesive layer disposed on the foil layer, and a paper layer disposed on the foil layer; adjusting the tension in the first length of insulated foil to maximize the ease with which the first length of insulated foil is to be cut and to be interleaved in a vertical orientation; adjusting the tension in the second length of insulated foil to maximize the ease with which the second length of insulated foil is to be cut and to be interleaved in a vertical orientation; cutting the first length of insulated foil into a plurality of first insulated foil sheets; cutting the second length of insulated foil into a plurality of second insulated foil sheets; folding each first insulated foil sheet of the plurality of first insulated foil sheets to create a crease that divides the first insulated foil sheet into a first upper leaf and a first lower leaf; folding each second insulated foil sheet of the plurality of second insulated foil sheets to create a crease that divides the second insulated foil sheet into a second upper leaf and a second lower leaf; orienting the first insulated foil sheet and the second insulated foil sheet in a vertical orientation; interleaving the first upper leaf of the first insulated foil sheet between the second upper leaf and the second lower leaf of the second insulated foil sheet; and interleaving the second lower leaf of the second insulated foil sheet between the first upper leaf and the first lower leaf of the first insulated foil sheet. In one aspect, the foil comprises aluminum. In another aspect, the adhesive comprises organic starch. In another aspect, the paper comprises craft paper. In another aspect, the first insulated foil sheet and the second insulated sheet are square or rectangular. In another aspect, the first crease is parallel to a first edge of the first insulated foil sheet and the second crease is parallel to a second edge of the second insulated foil sheet. In another aspect, the first insulated foil sheet or the second insulated foil sheet is folded such that the paper layer is inside the crease. In another aspect, the first insulated foil sheet or the second insulated foil sheet is folded such that the foil layer is inside the crease. In another aspect, the method further comprises packaging the plurality of insulated foil sheets in a container. In another aspect, the container comprises an opening through which each interleaved insulated foil sheet of the plurality of insulated foil sheets is disposed to be extracted or deployed. In another aspect, adding one or more additional insulated foil sheets to the first or the second insulated foil sheets.

In some embodiments of the disclosure, a container is disclosed as including a plurality of insulated foil sheets, each insulated foil sheet comprising a foil layer, an adhesive layer disposed on the foil layer, and a paper layer disposed on the foil layer; wherein a first insulated foil sheet of the plurality of insulated foil sheets is folded to create a first crease to divide the first insulated sheet into a first upper leaf and a first lower leaf and a second insulated foil sheet of the plurality of insulated foil sheets is folded to create a second crease to divide the second insulated sheet into a second upper leaf and a second lower leaf; and wherein the first upper leaf of the first insulated foil sheet is disposed between the second upper leaf and the second lower leaf of the second insulated sheet and the second lower leaf of the second insulated foil sheet is disposed between the first upper leaf and the first lower leaf of the first insulated sheet and additional insulated foil sheets are added until a container is filled to a pre-determined level. In one aspect, the container further comprises an opening through which each interleaved insulated foil sheet of the plurality of insulated foil sheets is disposed to be extracted or deployed. In another aspect, adding one or more additional insulated foil sheets to the first or the second insulated foil sheets.

### BRIEF DESCRIPTION OF THE DRAWINGS

For a more complete understanding of the features and advantages of the present invention, reference is now made to the detailed description of the invention along with the accompanying figures, in which:

FIG. 1 shows an exemplary interleaving machine.

FIG. 2 shows an exploded side view of a plurality of interleaved insulated foil sheets.

FIG. 3 shows a method implementation of the present invention.

### DETAILED DESCRIPTION OF THE INVENTION

Illustrative embodiments of the system of the present application are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

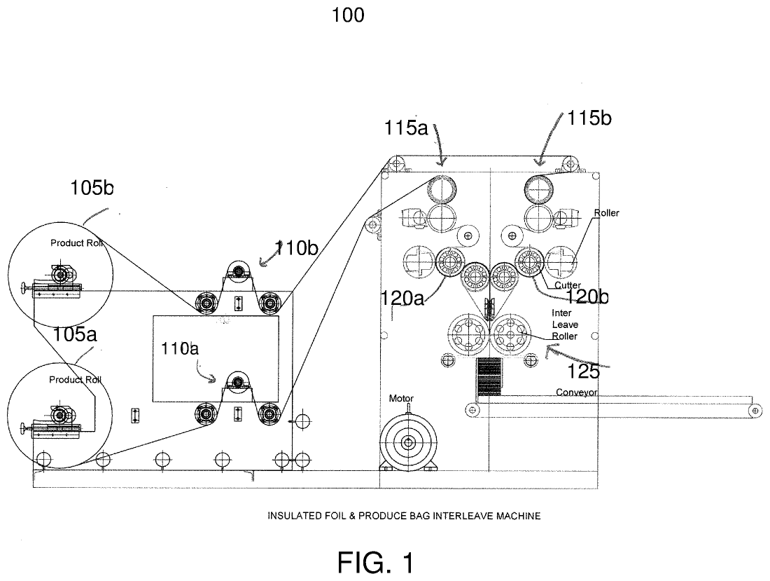

FIG. 1 shows an exemplary interleaving machine 100. The interleaving machine 100, when loaded with insulated foil, includes two rolls of insulated foil, first roll 105a and second roll 105b. The first roll 105a and the second roll 105b each include a foil layer and a paper layer held together by a layer of adhesive (layers not shown). The foil may include aluminum of a variety of grades and tempers, including grades and tempers commonly used in insulated foil. The paper may include craft paper. The adhesive may include organic starch. The layer of adhesive may be disposed in a pattern, e.g., a honeycomb pattern. The first roll 105a and the second roll 105b are unwound through the first sets of tensioning rollers 110a and 110b and through the second sets of tensioning rollers 115a and 115b, respectively. The first roll 105a and the second roll 105b then pass across cutters 120a and 120b, respectively, where the first roll 105a is cut to produce a first insulated foil sheet (not shown) and the second roll 105b is cut to produce a second insulated foil sheet (not shown). The first insulated foil sheet is folded to create a first crease (not shown) and the second insulated foil sheet is folded to create a second crease. The first insulated foil sheet and the second insulated foil sheet are interleaved by the interleave roller or rollers 125.

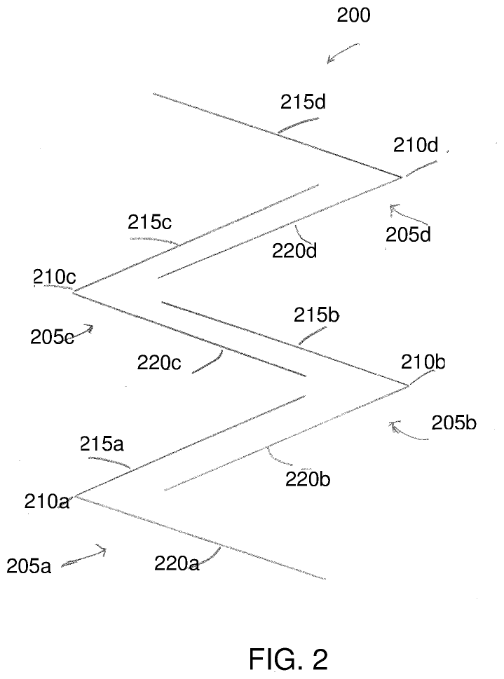

The first insulated foil sheet and the second insulated foil sheet may be creased and interleaved, e.g., by pushing the first insulated foil sheet at a place at which the first crease is to be formed in a first direction (e.g., right or left with reference to FIG. 1) and a first folding roller holds the first crease; then, the second insulated foil sheet is pushed at a place at which the second crease is to be formed in a second direction opposite to the first direction (e.g., left or right with reference to FIG. 1) and a second folding roller holds the second crease. In this example, the first insulated foil sheet and the second insulated foil sheet are cut and fed into the first folding roller and the second folding roller, respectively, such that they are offset from one another, and forming the first and second creases positions the first insulated foil sheet and the second insulated foil sheet with their respective upper and lower leaves to be interleaved as described herein and as shown in FIG. 2. In this example, the interleave roller or rollers 125 interleave the first insulated foil sheet and the second insulated foil sheet. This exemplary folding and interleaving continues with each second insulated foil sheet becoming the first insulated foil sheet in a pair with a new second insulated foil sheet to be folded and interleaved, until the desired number of sheets is interleaved to form a production unit of a plurality of interleaved insulated foil sheets, ready for packaging. The plurality of interleaved insulated foil sheets may be deposited, e.g., on a conveyer, as the sheets are interleaved until the desired number of sheets is interleaved, to be conveyed for packaging, and the folding and interleaving may continue for another production unit of a plurality of interleaved foil sheets. A plurality of interleaved foil sheets may be packaged in a container, e.g., a box or a bag. Such a container may include an opening through which each interleaved foil sheet may be disposed to be extracted or deployed.

FIG. 2 shows an exploded side view of a plurality of interleaved insulated foil sheets 200 including exemplary sheets 205a, 205b, 205c, and 205d. The sheets 205a and 205c are from the first roll 105a and the sheets 205b and 205d are from the second roll 105b. When each insulated foil sheet is folded to create a crease, the crease divides each sheet into an upper leaf and a lower leaf. Thus, the sheet 205a is folded at the crease 210a that divides the into an upper leaf 215a and a lower leaf 220a; the sheet 205b is folded at the crease 210b that divides the into an upper leaf 215b and a lower leaf 220b; the sheet 205c is folded at the crease 210c that divides the into an upper leaf 215c and a lower leaf 220c; and the sheet 205d is folded at the crease 210d that divides the into an upper leaf 215d and a lower leaf 220d. The interleave roller or rollers 125 interleave the sheets such that the upper leaf 215a of sheet 205a is disposed between the upper leaf 215b and the lower leaf 220b of sheet 205b, and the lower leaf 220b is disposed between the upper leaf 215a and the lower leaf 220a; the upper leaf 215b of sheet 205b is disposed between the upper leaf 215c and the lower leaf 220c of sheet 205c, and the lower leaf 220c is disposed between the upper leaf 215b and the lower leaf 220b; the upper leaf 215c of sheet 205c is disposed between the upper leaf 215d and the lower leaf 220d of sheet 205d, and the lower leaf 220d is disposed between the upper leaf 215c and the lower leaf 220c; and so on, until the desired number of sheets is interleaved to form a production unit of a plurality of interleaved foil sheets, ready for packaging. Additional foil sheets can be added until the container or packaging is filled to a pre-determined fill.

Interleaving foil/paper insulated sheets such as 205a, 205b, 205c, and 205d presents at least two difficulties. First, there tends to be an air gap between the foil layer and the paper layer that does not exist in other interleaved materials. This air gap makes cutting the sheets much more difficult than it would otherwise be. Second, the adhesive can be less effective in different interleaving orientations. Both of these problems are reduced by the present invention by fine tuning the tension in the unwinding stages in the first roll 105a, in the second roll 105b, or in both, to increase the ease with which the second length of insulated foil is to be cut and to be interleaved in a vertical orientation, which improves the effectiveness of the adhesive holding the foil and paper of each sheet together.

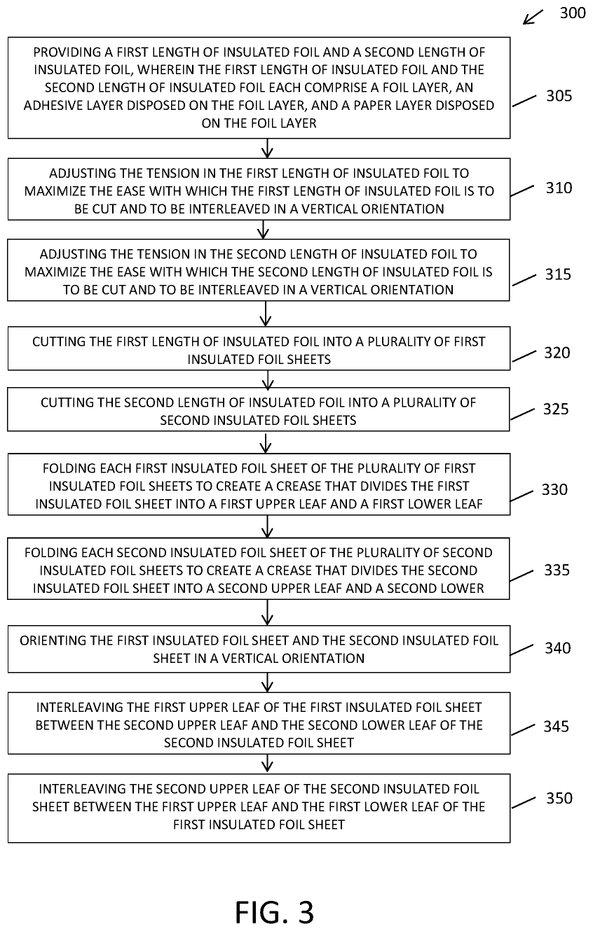

FIG. 3 shows a method implementation of the present invention, method 300. Method 300 includes block 305, providing a first length of insulated foil and a second length of insulated foil, wherein the first length of insulated foil and the second length of insulated foil each comprise a foil layer, an adhesive layer disposed on the foil layer, and a paper layer disposed on the foil layer. Block 310 includes adjusting the tension in a first length of insulated foil to maximize the ease with which the first length of insulated foil is to be cut and to be interleaved in a vertical orientation; and block 315 includes adjusting the tension in a second length of insulated foil to maximize the ease with which the second length of insulated foil is to be cut and to be interleaved in a vertical orientation. Cutting the first length of insulated foil into a plurality of first insulated foil sheets is included in block 320; and cutting the second length of insulated foil into a plurality of second insulated foil sheets is included in block 325. In block 330, each first insulated foil sheet of the plurality of first insulated foil sheets is folded to create a crease that divides the first insulated foil sheet into a first upper leaf and a first lower leaf; and in block 335, each second insulated foil sheet of the plurality of second insulated foil sheets is folded to create a crease that divides the second insulated foil sheet into a second upper leaf and a second lower leaf. Block 340 includes orienting the first insulated foil sheet and the second insulated foil sheet in a vertical orientation. Interleaving the first upper leaf of the first insulated foil sheet between the second upper leaf and the second lower leaf of the second insulated foil sheet is included in block 345; and block 350 includes interleaving the second lower leaf of the second insulated foil sheet between the first upper leaf and the first lower leaf of the first insulated foil sheet.

One skilled in the art will recognize that the plurality of interleaved foil sheets 200 and the method 300 for interleaving foil sheets provide the desired interleaved foil sheets that can be easily and cheaply interleaved.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of.” As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step, or a limitation) or group of integers (e.g., feature(s), element(s), characteristic(s), property(ies), method/process(s) steps, or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about,” “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

All of the devices and/or methods disclosed and claimed herein can be made and executed without undue experimentation in light of the present disclosure. While the devices and/or methods of this invention have been described in terms of particular embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope, and concept of the invention as defined by the appended claims.

Furthermore, no limitations are intended to the details of construction or design herein shown, other than as described in the claims below. It is therefore evident that the particular embodiments disclosed above may be altered or modified and all such variations are considered within the scope and spirit of the disclosure. Accordingly, the protection sought herein is as set forth in the claims below.

Modifications, additions, or omissions may be made to the systems and apparatuses described herein without departing from the scope of the invention. The components of the systems and apparatuses may be integrated or separated. Moreover, the operations of the systems and apparatuses may be performed by more, fewer, or other components. The methods may include more, fewer, or other steps. Additionally, steps may be performed in any suitable order.

To aid the Patent Office, and any readers of any patent issued on this application in interpreting the claims appended hereto, applicants wish to note that they do not intend any of the appended claims to invoke 35 U.S.C. § 112(f) as it exists on the date of filing hereof unless the words “means for” or “step for” are explicitly used in the particular claim.

What is claimed is:

1. A plurality of interleaved insulated foil sheets comprising:
a plurality of insulated foil sheets, each insulated foil sheet comprising a foil layer, an adhesive layer disposed on the foil layer, and a paper layer disposed on the foil layer;
wherein a first insulated foil sheet of the plurality of insulated foil sheets is folded to create a first crease to divide the first insulated foil sheet into a first upper leaf and a first lower leaf and a second insulated foil sheet of the plurality of insulated foil sheets is folded to create a second crease to divide the second insulated foil sheet into a second upper leaf and a second lower leaf; and
wherein the first upper leaf of the first insulated foil sheet is disposed between the second upper leaf and the second lower leaf of the second insulated sheet and the second lower leaf of the second insulated foil sheet is disposed between the first upper leaf and the first lower leaf of the first insulated sheet.

2. The plurality of interleaved insulated foil sheets of claim 1, wherein the foil layer comprises aluminum.

3. The plurality of interleaved insulated foil sheets of claim 1, wherein the adhesive layer comprises organic starch.

4. The plurality of interleaved insulated foil sheets of claim 1, wherein the paper layer comprises craft paper.

5. The plurality of interleaved insulated foil sheets of claim 1, wherein the first insulated foil sheet and the second insulated foil sheet are square or rectangular.

6. The plurality of interleaved insulated foil sheets of claim 1, wherein the first crease is parallel to a first edge of the first insulated foil sheet and the second crease is parallel to a second edge of the second insulated foil sheet.

7. The plurality of interleaved insulated foil sheets of claim 1, wherein the first insulated foil sheet or the second insulated foil sheet is folded such that the paper layer is inside at least one of the first or second crease.

8. The plurality of interleaved insulated foil sheets of claim 1, wherein the first insulated foil sheet or the second insulated foil sheet is folded such that the foil layer is inside the crease.

9. The plurality of interleaved insulated foil sheets of claim 1, wherein the plurality of insulated foil sheets is packaged in a container.

10. The plurality of interleaved insulated foil sheets of claim 9, wherein the container comprises an opening through which each interleaved insulated foil sheet of the plurality of insulated foil sheets is disposed to be extracted or deployed.

11. A method of interleaving a plurality of insulated foil sheets comprising:
providing a first length of insulated foil and a second length of insulated foil, wherein the first length of insulated foil and the second length of insulated foil each comprise a foil layer, an adhesive layer disposed on the foil layer, and a paper layer disposed on the foil layer;
adjusting a tension in the first length of insulated foil to cut the first length of insulated foil and to interleave in a vertical orientation;
adjusting the tension in the second length of insulated foil to cut the second length of insulated foil and be interleave in the vertical orientation;
cutting the first length of insulated foil into a plurality of first insulated foil sheets;
cutting the second length of insulated foil into a plurality of second insulated foil sheets;
folding each first insulated foil sheet of the plurality of first insulated foil sheets to create a crease that divides the first insulated foil sheet into a first upper leaf and a first lower leaf;
folding each second insulated foil sheet of the plurality of second insulated foil sheets to create the crease that divides the second insulated foil sheet into a second upper leaf and a second lower leaf;
orienting the first insulated foil sheet and the second insulated foil sheet in the vertical orientation;
interleaving the first upper leaf of the first insulated foil sheet between the second upper leaf and the second lower leaf of the second insulated foil sheet; and
interleaving the second lower leaf of the second insulated foil sheet between the first upper leaf and the first lower leaf of the first insulated foil sheet, and
optionally adding more insulated foil sheets to the first or the second insulated foil sheets.

12. The method of interleaving a plurality of insulated foil sheets of claim 11, wherein the foil layer comprises aluminum.

13. The method of interleaving a plurality of insulated foil sheets of claim 11, wherein the adhesive layer comprises organic starch.

14. The method of interleaving a plurality of insulated foil sheets of claim 11, wherein the paper layer comprises craft paper.

15. The method of interleaving a plurality of insulated foil sheets of claim 11, wherein the first insulated foil sheet and the second insulated sheet are square or rectangular.

16. The method of interleaving a plurality of insulated foil sheets of claim 11, wherein the first crease is parallel to a first edge of the first insulated foil sheet and the second crease is parallel to a second edge of the second insulated foil sheet.

17. The method of interleaving a plurality of insulated foil sheets of claim 11, wherein the first insulated foil sheet or the second insulated foil sheet is folded such that the paper layer is inside the crease.

18. The method of interleaving a plurality of insulated foil sheets of claim 11, wherein the first insulated foil sheet or the second insulated foil sheet is folded such that the foil layer is inside the crease.

19. The method of interleaving a plurality of insulated foil sheets of claim 11, further comprising packaging the plurality of insulated foil sheets in a container.

20. The method of interleaving a plurality of insulated foil sheets of claim 19, wherein the container comprises an opening through which each interleaved insulated foil sheet of the plurality of insulated foil sheets is disposed to be extracted or deployed.

21. A container comprising:
a plurality of insulated foil sheets, each insulated foil sheet comprising a foil layer, an adhesive layer disposed on the foil layer, and a paper layer disposed on the foil layer;
wherein a first insulated foil sheet of the plurality of insulated foil sheets is folded to create a first crease to divide the first insulated sheet into a first upper leaf and a first lower leaf and a second insulated foil sheet of the plurality of insulated foil sheets is folded to create a second crease to divide the second insulated sheet into a second upper leaf and a second lower leaf; and
wherein the first upper leaf of the first insulated foil sheet is disposed between the second upper leaf and the second lower leaf of the second insulated sheet and the second lower leaf of the second insulated foil sheet is disposed between the first upper leaf and the first lower leaf of the first insulated sheet and additional insulated foil sheets are added until a container is filled to a pre-determined level.

22. The container of claim 21, further comprising an opening through which each interleaved insulated foil sheet of the plurality of insulated foil sheets is disposed to be extracted or deployed.
